(19) United States
(12) Patent Application Publication
(10) Pub. No.: US 2005/0120303 A1
(43) Pub. Date: Jun. 2, 2005

(54) Smart multiedition methodology

(76) Inventor: Hassan Behbehani, Kuwait (KW)

Correspondence Address: Hassan Behbehani, P.O. Box: 1262 Safat, Kuwait, 13013, KW

(21) Appl. No.: 10/939,352

(22) Filed: Sep. 14, 2004

Related U.S. Application Data
(60) Provisional application No. 60/509,905, filed on Oct. 10, 2003.

(51) Int. Cl. G06F 17/24

(52) U.S. Cl. 715/540

(57) ABSTRACT

The present invention relates particularly to customize and create textbooks/e-books dynamically. The different parts of textbooks which need to be replaced are taken into data repository. The alternative parts which can be used in place of customizable locations of a textbook are also stored in repository. These parts and alternative parts may be in any language and in any length even a small word or character or picture can also be placed in customizable part and alternative part. These alternative parts are tagged with conditions or criteria under which these parts can replace the identified customizable parts of text book. The process takes the replacement criteria and replaces these customizable parts with alternative parts by comparing the tagged criteria with each alternative part with inputted replacement criteria.

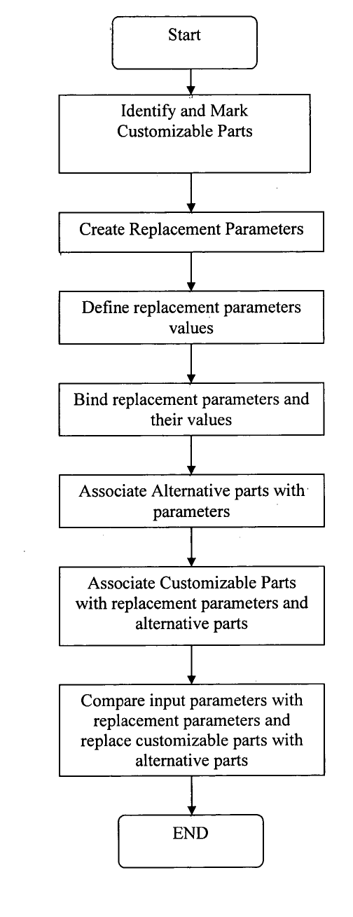

### BACKGROUND OF THE INVENTION

The present invention relates particularly to create textbooks and e-books dynamically. The process is like a printing press publishing a textbook or e-book according to different parameters such as readers' interests, hobbies, age, gender, IQ, culture, country\region . . . etc or other factors that can make the books more useful and attractive.

In the recent era, lot has already been done in the web technology and software technology to customize the contents according to users' choices. To present the information according to user's choice is not new way. There are many ways to customize the information based on one core theme i.e. Combination of “user Query” and “Event Driven Approach” For example, Web and software reports where user selects certain criteria, the underlying software analyzes the existing data repository and creates information based on these criteria dynamically. Another example might be “Mail Merge” feature of Microsfot Word where you can create mail and other documents and information dynamically. This phenomenon is also popular in many portals and web sites where contents can be created dynamically in hidden or visible manner to the user.

The core technique behind the scene is the same no matter which approach is used i.e. Mark the spots/patches which needs to replaced, compare and analyze the repository based on inputted parameters, collect or prepare the alternative patches and replace these prepared patches with marked spots/patches.

The presented invention can be useful for individuals such as students and learners and can also be helpful for publishing organizations and eLearning centers to present textbooks and e-books which are best suited for a particular entity. The invention is even more useful for creating multiple editions of textbook weather through software or web technology.

The invention presented here can play a vital role in education and learning process improvement. As different students have different mental level, different hobbies, and different interests and so on, the invention presented here can solve this problem by creating a customizable version that is best suited according to different parameters for a particular student. For example, a student may have interest in sports. So customizing the examples in any textbook related with sports can increase students' interest and passion in study.

The said invention can also be used to create editions that match with the local culture, events and environment. The invention may also be used to update old information with new and latest information in editions.

The said invention can also be useful for increasing the interest in learners and students who are studying books that are written by authors who belong to some different culture, region or religion. The said invention can also be used to publish different novels. The novels that are much relative to the user's mind are more attractive for the users. For example, famous novels or novels that have got noble-prize can be published using this technique to create their multiple editions that are much attractive for the readers. The presented invention can be used to create native editions of a book or textbook in the same culture from which the readers belong. This customization hence increases concentration and interest and focus of the readers. For example, a book is written in English language and American author. Just providing a bit customization can have amazing effects on readers like changing the characters names to local culture for example if reader is natively Arab, use names known in Arab, similarly for Asians use names that are popular in Asia and so. This scheme of customization can be-lifted up to individual countries and religions as well.

### BRIEF SUMMARY OF THE INVENTION

The present invention relates particularly to customize and create textbooks/e-books dynamically. The different parts and sections of book which can be customized are identified and marked. These parts may be in form of any repository such as document; database . . . etc and may be of any length such as single word. The process takes document(s), Original patches (the patches/parts in the book that will be replaced), New Patches (the portions/patches that will replace the original patches) and replacement criteria as input. Any of the document(s), criteria, Original Patches and new patches can be fed by the actor or some external/internal process or application. The input document can comprise text, document, figures, images and pictures. The input document can also be created from existing repository such as databases or some other repository.

The New patches are tagged with different parameters that are available dynamically to choose and construct. The process of creating and customizing the textbooks analyze the repositories and choose new patches dynamically based on replacement criteria. After the selection of new patches, these new patches are placed in place of old patches to create new edition which can be further modified and customized in similar or different way. In this way multiple editions/views/versions and revisions can be created automatically with ease.

### BRIEF DESCRIPTION OF THE DRAWINGS

There one drawing comprising the working of presented invention. The drawing is a flowchart of the overall process to customize textbooks. All the symbols used are the standard symbols used in flowcharts otherwise stated.

Sheet1: Technical flow of presented invention.

### DETAILED DESCRIPTION OF THE INVENTION

As discussed in the above sections, the presented invention is related particularly to create multiple editions of a textbook according to different parameters and criteria. At the beginning of the process, a new book is taken into data repository. The textbook for which multiple editions are needed can be provided by user or some external/internal application or process along with identification of customizable parts or portions. These parts or portions can be in any language and of any size.

After textbook is provided, it is taken into repository along with the marks on customizable parts. The customizable parts are tagged with uniquely identifiable marks. Again these customizable parts may be of any size, any length and these may be in any language.

Once customizable parts are saved and marked, replacements parameters or criteria are defined. These parameters or criteria can be defined by actor or some external/internal application or process with respect to the process or application in which the said invention is being used. These defined parameters can vary on the basis of nature of textbook. Each textbook may have different set of replacement parameters or each replacement parameters may belong to set of textbooks.

The replacement parameters are defined for the purpose of tagging these parameters with alternative parts and customizable parts. These parameters serve as bridge between customizable parts and the parts which will replace these customizable parts. Some examples of replacement parameters are age, gender, IQ, native language, region, religion, country, city, favorite color . . . etc. These parameters can be extended to any number and any length and of any kind.

After defining the replacement parameters, next step is to define values for each parameter. This may be called as replacement logic. This replacement logic is used to replace the alternative parts in place of customizable parts. Again the value(s) of any of the parameter may be in any size, of any kind (text, pictures, numbers . . . etc) and in any language. For example, Age parameter may have values as 10, 18 and above 18. Similarly culture parameter may have values like Arab, America, Asian . . . etc. After defining these values, the parameters and these values are tied together as shown in below table.

TABLE
Example showing how to tie replacement parameters and their values.

| Parameter(s) | Value(s) |
|---|---|
| AGE | <=10 |
| | 11 . . . 18 |
| | >18 |
| | . . . |
| GENDER | M |
| | F |
| | . . . |
| Culture | ARAB |
| | ASIAN |
| | AMERICAN |
| | G.C.C. |
| | ASIA-PACIFIC |
| | BRITIAN |
| | . . . |
| . . . | . . . |
| . . . | . . . |
| . . . | . . . |

As replacement parameters and values are defined, next step is to define and bind replacement parts which will be again bound with customizable parts. The replacement parameters and values will be conditions to select the appropriate alternative part to replace the customizable part. To complete the process, first replacement or alternative parts are defined. For example, suppose alternative or replacement parts are “RP1, RP2, RP3 . . . RPN”. Like the customizable parts, the replacement parts can be of any size, any kind (Text, Pictures, Voice, movie . . . etc), any format and can be in any language. These parts can be serialized and indexed to fasten the process but this is optional way. The process of defining alternative parts is independent of sequence as well means that they can be defined at any stage even before the marking of customizable parts. The alternative parts once defined can be saved and can be modified later to apply them with any other parameters and coincide them with any of the customizable parts of any text book. The alternative parts can be placed directly and tied with the replacement parameters and their values. Table below shows the definition and memorization of alternative parts which will replace the customizable parts according to inputted criteria and values of replacement parameters.

TABLE
Definition of replacement parts

| Sr# | Replacement Parts |
|---|---|
| 1 | RP1 |
| 2 | RP2 |
| 3 | RP3 |
| . . . | . . . |
| . . . | . . . |
| . . . | . . . |
| N | RPN |

After definition of alternative process, next is to bind these alternative patches with replacement parameters and their values. From these bindings the underlying software guesses which patches should be replaced. Each customizable part will have associated replacement parameters, their values and alternative patch. When actual input criteria are passed to the process, these parameters are compared with associated parameters and their values to select the appropriate alternative patch. Table below shows how the replacement parameters, values and alternative patches are associated.

| Parameter(s) | Value(s) | Replacement Part |
|---|---|---|
| AGE | <=10 | RP1 |
| | 11 . . . 18 | RP2 |
| | >18 | RP3 |
| | . . . | |
| GENDER | M | RP1 |
| | F | RP5 |
| | . . . | |
| Culture | ARAB | RP1 |
| | ASIAN | RP2 |
| | AMERICAN | RP3 |
| | G.C.C. | RP1 |
| | ASIA-PACIFIC | RP5 |
| | BRITIAN | RP6 |
| | . . . | . . . |
| . . . | . . . | . . . |
| . . . | . . . | . . . |
| . . . | . . . | . . . |

When the binding process is completed, the identified and marked customizable parts are associated with replacement parameters and alternative parts. Each customizable part has one attached parameter which can have multiple values and multiple alternative parts. Multiple parameters can be attached and associated with one customizable part. In such case, replacement part is selected on the basis of first parameter present in input criteria on priority basis. For example, suppose customizable parts are CP1, CP2, CP3 . . . CPN. Again each customizable part may be of any size, any kind (text, video, audio, movies . . . etc). Table below shows the process of associating customizable parts.

| Customizable Part | Parameter(s) | Value(s) | Replacement Part |
|---|---|---|---|
| CR1 | AGE | <=10 | RP1 |
| | | 11 . . . 18 | RP2 |
| | | >18 | RP3 |
| | | . . . | |
| CR2 | GENDER | M | RP1 |
| | | F | RP5 |
| | | . . . | |
| CR3 | Culture | ARAB | RP1 |
| | | ASIAN | RP2 |
| | | AMERICAN | RP3 |
| | | G.C.C. | RP1 |
| | | ASIA-PACIFIC | RP5 |
| | | BRITIAN | RP6 |
| | | . . . | . . . |
| . . . | . . . | . . . | . . . |
| . . . | . . . | . . . | . . . |
| . . . | . . . | . . . | . . . |

Now all the preconditions have met. Customizable parts can now be replaced by inputting the criteria. For example, consider the following.

| Customizable Part | Parameter(s) | Value(s) | Replacement Part |
|---|---|---|---|
| CR1 | AGE | <=10 | RP1 |
| | | 11 . . . 18 | RP2 |
| | | >18 | RP3 |

If user want create different edition on basis of age, the above table can be helpful. If input criteria are Age (10) then in this edition CR1 part will be replaced by RP1. If input criteria are Age (16), RP2 will be placed in position of CR1 and if Age (30) is criteria, RP3 will replace CR1 and so on.

Similarly every customizable part is replaced. These replaced parts are taken into repository to create a new again customizable edition. The replaced parts are embedded into the original whole text book in place of customizable parts. In such way, multiple editions of a textbook can be created with ease and dynamically. The similar process is adopted for the e-books and in books that are provided by eLearning centers to teach their students online on internet or in form papers to save time.

1. A method for creating multi-editions wherein the said method including:
identifying the book required to be processed through an input device;
Identifying the replaceable portions of a book
Creating and identifying parameters according to which different editions of a book can be created
Identifying values for each parameter as identified in creating and identifying parameters step
Creating alternative potions of book to be replaced with replaceable potions
Attaching parameters identified in creating and identifying parameters step with replaceable portions of the book
Attaching alternative portions with values of parameters
Creating the specific edition
Storing the created edition
Returning the created edition to output device
input device means a device capable of input data into method through electrical, mechanical or digital signals, thereby signals understandable for the method such as mouse, keyboard, scanner . . . etc
output device means the device, thereby the generated editions are transferred to output device.
Book means a material comprising different sort of content such as text, images, photographs . . . Etc. The said method keeps the identity of page sequences and chapters.

2. The method as claimed in claim 1, wherein identifying replaceable potions step including:
replaceable portions are independent of size and nature.
Independent of size means replaceable portions may be of any size from single character to a paragraph.
Independent of nature means replaceable portions may be of any nature including text, images, photographs . . . etc.

3. The method as claimed in creating and identifying parameters step in claim 1, wherein said method including:
Moving a single parameter
Moving multiple parameters
Adding new parameters
Editing existing parameters
Deleting parameters
Template parameters.
Copy and pasting single parameters
Copy and pasting multiple parameters

4. The method as claimed in claim 1, wherein Identifying values for each parameter step including:
Parameter values are independent of size and nature.
Independent of size means values may be of any size from single character to a paragraph.
Independent of nature means values may be of any nature including text, images, photographs . . . etc.

5. The method as claimed in claim 1, attaching parameters identified step as in claim 1, wherein the said method including:
multiple parameters can be attached with single replaceable portion

6. The method as claimed in claim 5, wherein the said method including:
setting parameter priority for each of the attached parameter

7. The method as claimed in claim 6, wherein the said method including:
providing a tool to increase or decrease the priority of parameters;
moving the parameters across the parameters priority list;

8. The method as claimed in claim 1, wherein creating alternative portions step including:
alternative portions are independent of size and nature.
Independent of size means alternative portions may be of any size from single character to a paragraph.
Independent of nature means alternative portions may be of any nature including
text, images, photographs . . . etc.

9. The method as claimed in claim 1, wherein creating specific edition step including:
selecting values for identified parameters

10. The method as claimed in claim 9, wherein said method including:
pick the first replaceable portion
identify the attached parameters with this replaceable portion
identify the parameters from attached parameters that have been provided values
identify the parameter having most high priority
replace the replaceable portion with attached alternative portion depending upon the value of parameter identified in above step
repeat the above steps until all replaceable portions have been processed or replaced

11. The method as claimed in claim 1, wherein said method including:
providing a navigation tool for allowing the users to view the different parts of book by navigating along the different pages of a book

12. The method as claimed in claim 1, wherein the said method including:
providing a navigation tool for allowing the users to view the different replaceable and alternative portions of book by navigating along the portions of a book

13. A method as claimed in claim 1, wherein said method including:
storing and transferring the created editions on different type of media and different format

14. A method as claimed in claim 1, wherein said method including:
A tool for material management on server or client wherein the said tool capable of the operations:
Adding the books (material) into the server or client computer
Storing the books (material) at appropriate locations
Retrieving the previously stored books (material)
Editing the previously stored books (material)
Deleting the stored books (material)
Adding, editing and deleting categories used for books (material) management
Allowing Addition, edition and deletion of sub categories under categories used for books (material) management
Managing the stored books (material) into different categories and sub categories

15. A tool implementing the method as claimed in claim 1, wherein the said tool including:
creating editions and storing these editions automatically at the specified location for the specified parameter values

16. A method as claimed in claim 1, wherein the said method including:
A method for use in a data network supporting World Wide Web (Web) communications wherein books, replaceable portions, alternative portions and related stuff is stored by a server and accessible by clients in the form of Web pages or in any other appropriate format for viewing, editing and creating multi editions of the material:

17. A method as claimed in claim 1, wherein said method including:
said method for use in a communications network having a server and clients linked by a data network wherein books, replaceable portions, alternative portions and related stuff is stored by the server and users at the clients access the material for viewing, editing and creation of multi editions and multi versions of the material;

18. A method as claimed in claim 1, wherein said method including:
The said method for use on personal computer
